(19) United States
(12) Patent Application Publication
(10) Pub. No.: US 2003/0110484 A1
(43) Pub. Date: Jun. 12, 2003

(54) Method and apparatus utilizing bluetooth transmission protocols to update software resident on a network of computing devices

(76) Inventor: David Famolari, Montclair, NJ (US)

Correspondence Address: Joseph Giordano, Esq., Telcordia Technologies, Inc., 445 South Street, Room 1G-112R, Morristown, NJ, 07960, US

(21) Appl. No.: 10/015,963

(22) Filed: Dec. 10, 2001

(51) Int. Cl. G06F 9/44; G06F 9/445

(52) U.S. Cl. 717/173; 717/170; 717/178

(57) ABSTRACT

A method and associated apparatus for rapidly and efficiently updating, from a remote location, selected software that is resident on a plurality of networked computing devices that may be dissimilar. In an illustrative embodiment, in which the updated version is resident at a prescribed address on an Internet web server that is accessible through the backbone network, each of the computing devices is provided with an additional radio interface adapted for Bluetooth transmission. Bluetooth messages may be sent to each of the devices from a suitable command source, illustratively a handheld Bluetooth terminal. After the terminal has determined, through conventional Bluetooth inquiries, which of the networked computing devices contains the relevant software, the terminal issues a suitable Bluetooth service request message to discover a first subset of such devices that contains an outdated version of such software. The terminal then transmits a Bluetooth message informing each device in such first subset of the web server address where the updated version resides, and commands such device to download the updated version from the relevant address.

### BACKGROUND OF THE INVENTION

This invention relates to systems of networked computers, and more particularly to arrangements for updating software that is resident on such computers.

It is known to associate a plurality of computing devices with each other through a backbone network. The several computing devices are coupled to the network through network interfaces, and they cooperate to perform various tasks that may be implemented by software resident on the respective devices.

It is further known to update such resident software by downloading a later version of the software from a remote location. However, implementing such downloading in those cases requires predetermining which of the networked computing devices are in need of such updating as well as directing the downloading of the updated software to only such computers. Up to now, such updating of the resident software has been inefficient and difficult to accomplish rapidly and with a minimum of human intervention, particularly when the network devices are dissimilar.

### SUMMARY OF THE INVENTION

The present invention provides a technique for rapidly and efficiently implementing, from a remote location, the update of selected software that is resident on a plurality of networked computing devices that may be dissimilar. In an illustrative embodiment, in which the updated version is resident at a prescribed address on an Internet web server that is accessible through the backbone network, each of the computing devices is provided with an additional radio interface adapted for Bluetooth transmission. Bluetooth messages may be sent to each of the devices from a suitable command source, illustratively a handheld Bluetooth terminal. After the terminal has determined, through conventional Bluetooth inquiries, which of the networked computing devices contains the relevant software, the terminal issues a suitable Bluetooth service request message to discover a first subset of such devices that contains an outdated version of such software. The terminal then transmits a Bluetooth message informing each device in such first subset of the web server address where the updated version resides, and commands such device to download the updated version from the relevant address.

In an illustrative feature of the invention in which the number (N) of devices in the first subset is greater than maximum number (7) of devices that define a Bluetooth piconet, the devices are subdivided into groups of not more than N/7 devices each. The Bluetooth download commands from the terminal are then applied to the several groups in sequence. The devices in each group are relegated to a Bluetooth PARK mode up to the time the download commands are to be applied to that particular group, at which time active connections to such group are restored.

In addition, in accordance with the present invention multiple updates can occur based on a single command action executed on a single mobile device. Furthermore, machines within close proximity of an handheld Bluetooth device may be updated.

### BRIEF DESCRIPTION OF THE DRAWING

These and other features, aspects and examples of the invention are further set forth in the following detailed description taken in conjunction with the appended drawing, in which:

FIG. 1 is a representation, primarily in block diagram form, of an arrangement of computing devices associated through a backbone network, the devices having software resident thereon that may be updated in accordance with a first implementation of the invention;

FIG. 2A is a sequence diagram of Bluetooth messages through which the terminal of FIG. 2 may implement such software updating;

FIG. 2B is a sequence diagram similar to FIG. 2A but depicting some additional Bluetooth messages that may be employed in the arrangement of FIG. 1 to subdivide the network of FIG. 1 into groups to be sequentially updated;

FIG. 3 is a block diagram of an illustrative embodiment of a Bluetooth terminal suitable for implementing the sequence of messages represented in FIGS. 2A-2B; and

FIG. 4 is a representation, similar to FIG. 1, depicting a modified arrangement of networked computing devices containing software that may be updated in accordance with a second implementation of the invention.

### DETAILED DESCRIPTION

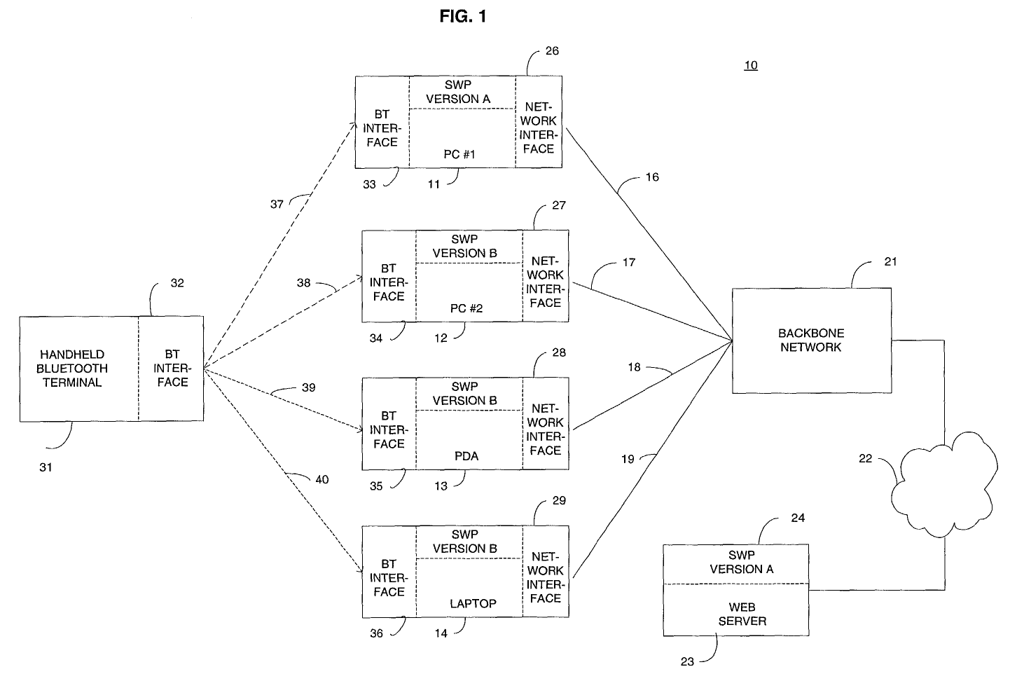

Referring now to the drawing, FIG. 1 illustrates a network 10 having a plurality of computing devices, four of which are depicted at 11, 12, 13 and 14. The devices 11-14 are in communication through links 16, 17, 18 and 19 with a conventional backbone network 21. Illustratively, the backbone network 21 is coupled to the Internet represented at 22, which in turn is coupled to a conventional web server 23. An address 24 of the server 23 is assumed to house the latest version (version A) of a predetermined software package represented as SWP, a version of which is resident on the devices of the network 10 to execute a predetermined task.

Some or all of the devices 11-14 may be dissimilar. As exemplified in FIG. 1, the devices 11 and 12 are each personal computers, the device 13 is a personal digital assistant, and the device 14 is a laptop computer. The devices 11-14 are respectively provided with network interfaces 26, 27, 28 and 29 which may support hardwired connection to the backbone network 21 via the links 16-19. Alternatively, the interfaces 26-29 may support a radio transmission protocol such as IEEE 802.11, in which case the links 16-19 may encompass an intermediate radio network (not shown).

As further indicated in FIG. 1, the device 11 is already loaded with the latest version A of a the software package SWP. By contrast, the devices 12-14 are assumed to be initially loaded with an obsolete version B of the package SWP, which latter version is to be updated to version A in the manner described below.

In accordance with the invention, such updating of those devices that contain an obsolete version of the package SWP may be efficiently carried out on a remote basis with the use of a separate Bluetooth terminal, represented at 31. The terminal 31 is assumed to be within Bluetooth range of at least the depicted devices 11-14 and is preferably a handheld device. The terminal 31 has a radio interface 32 which is connectable to a plurality of Bluetooth interfaces 33, 34, 35 and 36 of the devices 11-14 through associated radio channels 37, 38, 39 and 40 .The channels 37-40 may in turn be established by a Bluetooth radio module (not shown) associated with the terminal 31.

As described below, Bluetooth messages from the terminal 31 control a sequence of operations for updating the devices 12-14 to the latest version A of the package SWP through, e. g., the downloading of such version A from the relevant address 24 of the web server 23. Specifically, each of the devices 12-14, as directed by the terminal 31, may retrieve such version A from the web server 23 by sending suitable conventional retrieval commands through the associated one of the network interfaces 17-19, the backbone network 21, and the Internet 22.

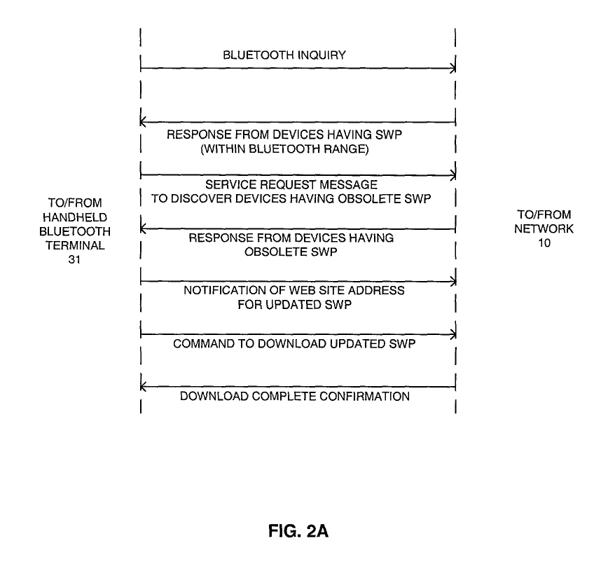

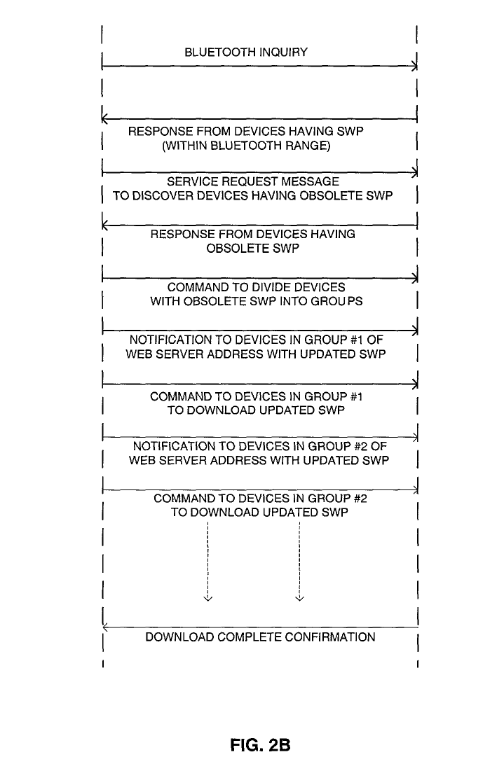

The manner in which the Bluetooth terminal 31 may illustratively implement a software updating operation of the type just described will now be described in connection with FIGS. 1, 2A and 2B. Initially, the terminal 31 transmits a Bluetooth inquiry over the channels 37-40 to the devices 11-14 on the network 10. Such inquiry is suitably designed to elicit responses from all the devices which are in Bluetooth range of the terminal 31 and on which some version of the software package SWP is resident. In response to such inquiry, the device 11 with the latest version A as well as the devices 12-14 with the obsolete version B may respond with appropriate Bluetooth acknowledgments.

The terminal 31 then broadcasts a Bluetooth service request message suitable to discover a first subset of the responding devices in which the outdated version of the software is resident. For the arrangement depicted in FIG. 1, responses to such service request message are received by the terminal 31 only from the subset consisting of the devices 12, 13 and 14. The terminal may terminate the Bluetooth connection with the non-responding device 11 over the channel 37.

When the terminal 31 receives such responses to the service request message, it transmits a Bluetooth message that informs each of the devices 12-14 of the web server address 24 from which version A of the software package SWP may be obtained. Following such information message and any conventional acknowledgments thereof by the devices 12-14, the terminal 31 transmits an additional Bluetooth message commanding each of the devices 12-14 to download version A of the relevant software from the web server 23. In response to such download command message, each of the devices 12-14 retrieves version A from the web server 23 in the manner noted above and overwrites the earlier version B resident thereon. When such downloading is complete, the devices 12-14 may send confirming messages to this effect to the terminal 31. Once all the reception is confirmed back to the handheld Bluetooth terminal, the Bluetooth connections may be dropped or continue to be maintained. Where the connections are maintained the network terminals that are downloading software may provide the handheld Bluetooth device indications on the software updating progress.

It will be appreciated by those skilled in the art that while, for clarity of description, the network 10 is shown with a total of four devices (devices 11-14) with three of them (devices 12-14) qualifying for software updating as indicated above, in a more general case the network 10 may contain any reasonable number of such devices in each such category. And if, for example, the number of devices qualifying to be updated is greater than the number (7) that conventionally defines a Bluetooth piconet, the terminal 31 may be suitably adapted to transmit additional Bluetooth messages as represented in FIG. 2B for the purpose of (1) dividing the qualifying devices into groups of no more than 7 devices each and (2) transmitting the above-mentioned notification and download command messages to each of the groups in sequence. With this modification, an active Bluetooth mode need be maintained only with the devices of the group then selected for updating, while the devices in those groups that have not yet been selected for updating are placed in a conventional Bluetooth PARK mode. After a selected group of devices has executed the associated download commands, the associated Bluetooth connections from the terminal 31 may be terminated.

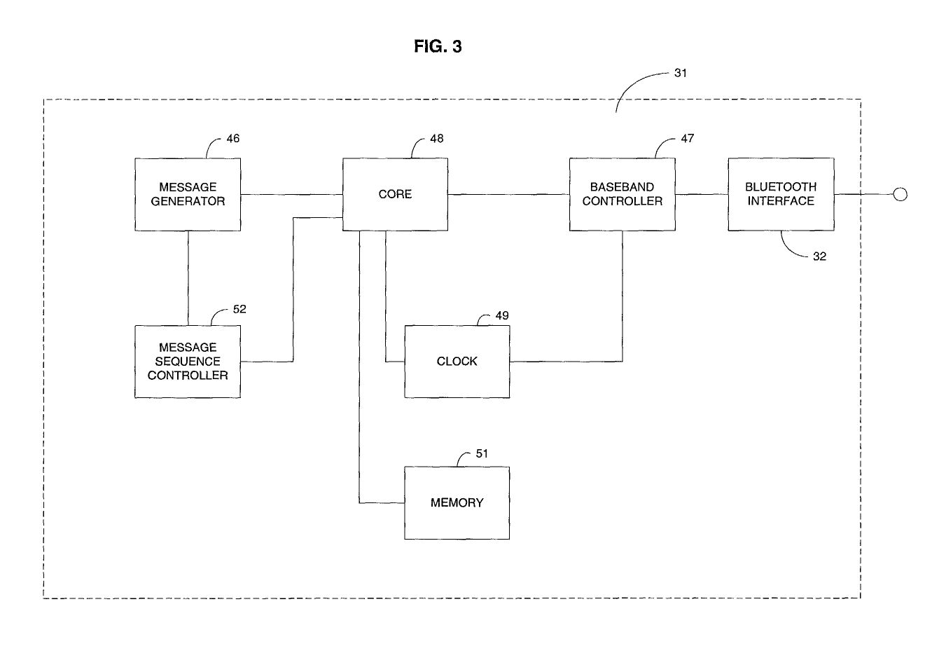

An illustrative embodiment of the Bluetooth terminal 31 is indicated in FIG. 3. The above-described Bluetooth messages are created in a suitable generator 46. Such messages are converted into suitable Bluetooth transmission format with the aid of a conventional baseband controller 47 which is coupled to the generator 46 through a CPU core 48. The core 48 is in turn associated with a system clock 49 and a memory 51, with the clock 49 being used to establish time slots for the Bluetooth frequency hopping patterns from the baseband controller 47 in a conventional manner. The output of the baseband controller 47 is applied through the Bluetooth interface 32 to modulate the carrier frequency of a suitable Bluetooth radio module (not shown). As indicated before, such module establishes the several Bluetooth channels with the network 10, including the channels 37-40 specifically depicted in FIG. 1.

The generator 46 (FIG. 3) is also coupled to a message sequence controller 52, which establishes the sequence of messages depicted in FIGS. 2A and 2B, respectively. For this purpose, responses from the appropriate devices on the network 10 to the various Bluetooth messages from the terminal 31 may be routed to the sequence controller 52 from the core 48 to help assure that each message is directed solely to the devices that have transmitted the appropriate Bluetooth response to the previously generated message.

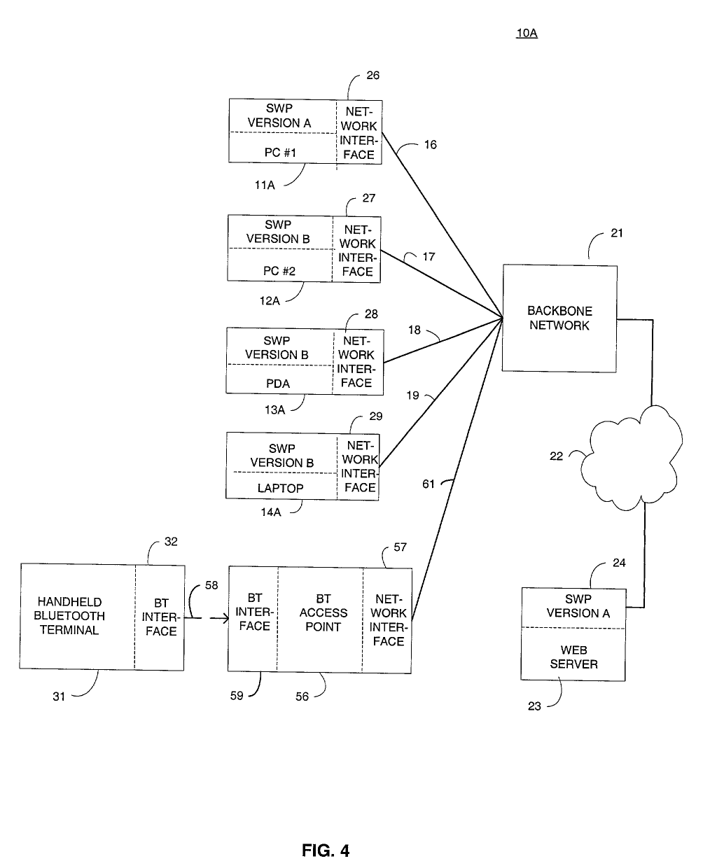

The arrangement of FIG. 4 shows a variation of the above-described technique for updating networked computing drevices in acordance with the invention. (Corresponding elements in FIGS. 1 and 4 have been given corresponding reference numerals.) FIG. 4 depicts a network 10A containing computing devices 11A-14A that are similar to the devices 11-14 of FIG. 1 but lack a Bluetooth interface. The network 10A further contains a Bluetooth access point 56, which is connected through a network interface 57 to the backbone network 21.

In general, the sequence of Bluetooth messages outlined in FIGS. 2A-2B in connection with the arrangement of FIG. 1 will apply to the arrangement of FIG. 4. However, the arrangement of FIG. 4, rather than establishing a plurality of Bluetooth channels between the terminal 32 and the respective networked devices11A-14A, establishes a single Bluetooth connection represented at 58 between the interface 32 of the terminal 31 and a corresponding Bluetooth interface 59 of the access point 56. Bluetooth messages from the terminal 31 similar to those shown in FIGS. 2A and 2B are routed to the devices 11A-14A through the access point 56 and the backbone network 21 via a connection 61, and the responses from such devices to those messages are directed, as appropriate, through their individual links 16-19 to the backbone network 21 and over the connection 61 to the access point 56. Such access point then returns such responses to the terminal 31 via the Bluetooth connection 58. In all other respects, the operation of the arrangement of FIG. 4 will be identical to that described above in connection with FIGS. 1-3.

In the foregoing, the invention as been described in connection with several embodiments thereof. Many variations and modifications will now occur to those skilled in art. It is accordingly desired that the scope of the appended claims not be limited to or by the specific disclosure herein contained.

What is claimed is:

1. A method of updating software resident on a first plurality of computing devices each having a first interface that is connectable to a first network, the first network having a first address at which an updated version of the software is resident, the method comprising the steps of:
determining, through a first Bluetooth message, the existence of a first subset, if any, of the devices on which a non-updated version of the software is resident;
informing each device in the first subset, through a second Bluetooth message, of the first address; and
commanding each device in the first subset, through a third Bluetooth message, to download the updated version from the first address.

2. A method as defined in claim 1, in which the first plurality of devices form part of a larger second plurality of devices each having the first interface, and in which the method further comprises the step, prior to the determining step, of interrogating the second plurality of devices with a Bluetooth inquiry to seek responses from devices that contain the software, whereby only the first plurality of devices respond to such inquiry.

3. A method of updating software resident on a first plurality of computing devices each having a first interface for establishing a Bluetooth connection and a second interface that is connectable to a first network, the first network having a first location at which an updated version of the software is resident, the method comprising the steps of:
establishing a Bluetooth connection to each device in the first plurality through its associated first interface;
transmitting a Bluetooth message to each device in the first plurality to determine a first subset, if any, of the devices on which a non-updated version of the software is resident;
informing each device in the first subset, through its Bluetooth connection, of the first address; and
commanding each device in the first subset, through its Bluetooth connection, to download the updated version from the first network via its second interface.

4. A method as defined in claim 3, in which the first plurality of devices form part of a larger second plurality of devices each having the first and second interfaces, and in which the method further comprises the step, prior to the establishing step, of interrogating the second plurality of devices with a Bluetooth inquiry to seek responses from devices that contain the software, whereby only the first plurality of devices respond to such inquiry.

5. A method as defined in claim 3, in which the steps of the method are executed with a handheld Bluetooth terminal.

6. A method as defined in claim 3, further comprising the step of terminating the Bluetooth connection to each device that is not part of the first subset.

7. A method as defined in claim 3, in which the method further comprises the step of subdividing the first subset into groups of no more than X devices each, and in which the instructing step is accomplished sequentially group by group.

8. A method as defined in claim 7, in which X=7.

9. A method as defined in claim 3, in which the informing step is accomplished sequentially group by group in timed relation to the commanding step.

10. A method as defined in claim 3, further comprising the step of terminating the respective Bluetooth connections to the devices of each group after execution of the commanding step associated with that group.

11. A method as defined in claim 3, further comprising the steps of placing the devices of each group in a Bluetooth PARK mode prior to the start of the commanding step associated with that group, and placing such devices in a Bluetooth active mode at the start of the associated commanding step.

12. For use with a system comprising a first plurality of computing devices each having at a first software package resident thereon, each device further having a first Bluetooth interface and a second interface that is connectable via a non-Bluetooth transmission path to a first network, the first network having a first address at which an updated version of the first software package is resident:
a terminal for establishing a Bluetooth connection with the first interface of each device in the first plurality, the terminal comprising, in combination, means for determining a first subset, if any, of the devices on which a non-updated version of the first software package is resident; means for informing each device in the first subset of the first address; and means for commanding each device in the first subset to download, via its second interface, the updated version from the first address.

13. A terminal as defined in claim 12, further comprising means for transmitting a Bluetooth inquiry to seek responses from devices that contain the first software package.

14. A terminal as defined in claim 12, further comprising means for subdividing the first subset into groups of no more than X devices each.

15. A terminal as defined in claim 12, further comprising means for terminating the respective Bluetooth connections to the devices of each group.

16. A terminal as defined in claim 12, further comprising means for selectively placing the devices of each group in a Bluetooth PARK mode and in a Bluetooth active mode, respectively.
